(19) United States
(12) Patent Application Publication
(10) Pub. No.: US 2023/0329303 A1
(43) Pub. Date: Oct. 19, 2023

(54) TASTE TAILORING AND/OR FLAVOR CLOAKING COMPOSITIONS AND METHODS

(71) Applicant: Health Remedies LLC, Palo Alto, CA (US)

(72) Inventors: Alan Rustin Greene, Pacifica, CA (US); Cheryl Lorraine Greene, Pacifica, CA (US); Rajesh Grover, Del Mar, CA (US); Hallie Kimberly Heiman Walls, Los Angeles, CA (US); Agatha Relota Luczo, Atherton, CA (US)

(73) Assignee: Health Remedies LLC, Palo Alto, CA (US)

(21) Appl. No.: 17/367,258

(22) Filed: Jul. 2, 2021

(51) Int. Cl. A23L 33/10; A23L 33/00; A23L 2/56

(52) U.S. Cl. CPC A23L 33/10; A23L 33/30; A23L 2/56

(57) ABSTRACT

Compositions and/or methods for influencing, or more preferably tailoring, the taste preferences of unborn infant children, or breast feeding children. In other embodiments, compositions or methods for selectively cloaking the taste of certain flavor compounds and/or manufacturing methods or processes for producing edible (or drinkable) products which include selective and/or tailorable flavor cloaking capabilities or functions. In certain embodiments, methods or processes for producing edible or drinkable products for influencing (or tailoring) the taste preferences of unborn, in utero children, or breast feeding children.

### TECHNICAL FIELD

The various inventions disclosed in this patent application generally relate to compositions and/or methods for influencing, or more preferably tailoring, the taste preferences of unborn infant children, or children which are breast feeding. In other embodiments, the inventions disclosed below relate to compositions or methods for selectively cloaking the taste of certain flavor compounds and/or relate to manufacturing methods or processes for producing edible (or drinkable) products which include selectively cloaked flavors, or which are useful for selectively cloaking flavors. In certain embodiments, the methods or processes are for producing edible or drinkable products for influencing (or tailoring) the taste preferences of unborn, in utero children, or children which are breast feeding.

### BACKGROUND OF THE INVENTIONS

Flavor, as best as it is understood, is the individual human perception of the detection of molecules by the olfactory and gustatory systems of the human body. It is generally, if not universally, recognized that humans detect five basic tastes with taste buds: sweet, salty, sour, bitter, and umami. Nevertheless, each human's perception and judgment of actual food flavors —which comprise nuanced variants and combinations of the five basic “tastes”—varies considerably based on developmental as well as environmental exposures and experiences. Specifically, it is believed that, from infancy until adulthood, flavor preferences as well as distastes for flavors (i.e., likes and dislikes) are influenced by the foods a person is exposed to over their lifetime, and during their childhood in particular.

For example, one hypothesis for the origin of food flavor preferences (or, conversely, flavor aversions) is evolutionary in nature. In particular, it is believed that children evolve from a Darwinian “fitness” or survival-to-procreate perspective to disfavor and even shun foods that they have not experienced in the past. This is because—it is postulated—that if a food flavor has not been introduced to the child by its mother (or other parent), the reason may be explained by the food's poisonous or otherwise harmful nature. In modern society, however, and in countries like the United States in particular, the abundance and consumption of natural, locally available healthy foods has largely been replaced by “processed” food products made and/or created by corporations, which no longer resemble foods which originate in nature. Accordingly, because “corporate food” is often manufactured with an emphasis on cost efficiency, rather than flavor diversity or nutrition, the palettes of flavors to which children in countries like the United States are exposed are typically limited, with outsized deficiencies with respect to exposure to fruits and vegetables.

Among other things, it is believed that a childhood obesity epidemic has emerged in the United States as a consequence of these non-diverse food exposures. That is, approximately ⅔^{rds} of United States' high school students now present with symptoms of metabolic disorders resulting from poor nutrition and/or unhealthy body weights. These potentially dangerous health conditions include elevated blood pressure, elevated blood glucose, elevated triglycerides, elevated cholesterol, and other metabolic and health disorders.

While a simple solution for both children and adults with poor, non-diverse diets would seem to be issuing a directive to eat more fruits and vegetables (and less processed foods), changing the eating habits of both children and adults has proved to be problematic at best. For example, adults that attempt to change eating habits by “dieting” typically revert to past ingrained “bad” eating habits, even if their improved eating habits are a success at first. Often even more difficult, children will frequently simply refuse to try new foods at all, let alone permanently change eating habits as a consequence of casual parental intervention. Moreover, some parents simply do not have the fortitude, or the time, to take the steps necessary to engrain new eating habits and/or preferences in their children.

Referencing the above-described and heretofore unresolved difficulties and problems in the prior art pertaining to lack of adequate nutrition or diversity in typical diets, the applicants for the inventions described herein have addressed, overcome, and/or solved such difficulties and/or problems (in whole or in part) with one or more of the below-described methods, processes, compositions, or apparatus. It is also a purpose of the herein described methods, processes, compositions, or apparatus to address other drawbacks and/or other desires for improvements in the art, whether or not currently known, which will become more apparent to the skilled artisan once given the present disclosure.

### SUMMARY OF INVENTION

The inventions described herein, in some embodiments, relate to methods and mechanisms to solve or at least ameliorate problems and needs in the art related to lack of flavor acceptance and/or lack of nutritional diversity in human diets, including as a result of the resistance of humans to voluntarily modify their food preferences for sustained durations. More specifically, in some embodiments, the inventions described herein pertain to methods and/or compositions for changing and/or influencing—and more preferably tailoring—the food taste preferences of children and/or adults. The inventions described herein also relate, in some embodiments, to manufacturing methods for producing edible or drinkable compositions which are capable of changing, influencing, and/or tailoring such food taste preferences. Other inventions described herein relate to taste cloaking compositions and methods, and/or processes for making edible and drinkable products which include taste cloaking compositions and/or functionalities.

In one particularly preferred embodiment of one of the described inventions, the inventors have discovered that it is possible to influence and/or tailor the flavor and/or taste preferences of unborn children by delivering flavor molecules to a child in utero using the amniotic fluid of the mother carrying the unborn child as a vehicle to deliver such flavor molecules. In particularly innovative embodiments of this invention (though not required for all embodiments), the flavor molecules are delivered when the expectant mother ingests an edible or drinkable product containing the molecules, but where the flavor molecules are encapsulated, cloaked, or disguised, using one or more mechanisms or techniques, so that the expectant mother does not herself “taste” the taste-tailoring-molecule delivery. Of course, it is anticipated that the taste-tailoring-molecules can be cloaked entirely or they may be delivered such that even though they are detected by the mother, the intensity of their expression to the mother is not offensive to the expectant mother's taste palette. The reason for cloaking or disguising the taste-tailoring-molecules from the mother is that (the applicants herein have discovered), among mothers with existing poor personal diets, some mothers will refuse or otherwise be resistant to changing their own eating or other behavioral habits, even if it is in the best interests of their child.

In at least one embodiment of one of the taste cloaking inventions, therein is provided: a food product for tailoring the taste preferences of a child in utero, wherein the food product includes means to cloak at least a first flavor to prevent a pregnant woman from consciously taste-recognizing the at least first flavor; and wherein, after the food product is ingested by a pregnant woman and has passed by the gustatory system of the pregnant woman, the means to cloak the at least first flavor is designed to thereafter uncloak the first flavor, such that the first flavor is taste-recognizable by an infant in utero carried in the womb of the pregnant woman. In one (non-limiting) version of such taste cloaking embodiments, the means to cloak comprises an encapsulating mechanism for encapsulating flavor molecules so that such flavor molecules are not consciously detected by the gustatory system of a pregnant woman ingesting such encapsulated flavor molecules; and the encapsulating mechanism releases the flavor molecules after passing by the gustatory system of the pregnant woman such that the flavor molecules are non-encapsulated within the amniotic fluid of the pregnant woman such that an infant in utero taste-recognizes the flavor molecules.

Other mechanisms for cloaking flavor molecules are of course envisioned. For example, the inventor has discovered that certain compositions when delivered in an edible (or drinkable) product are capable of cloaking or disguising one or more taste-tailoring-molecules delivered simultaneously with the cloaking (or disguising) composition. In one such alternative embodiment, there is provided: a food product for tailoring the taste preferences of a child in utero comprising: a first composition comprising a flavor cloaking composition; and a second composition comprising a flavor tailoring composition. In this (non-limiting) embodiment, the flavor cloaking composition is compositionally configured to be detected by the gustatory system of the pregnant woman and is further compositionally configured to suppress (or prevent or at least lessen) the pregnant woman's gustatory detection of the flavor-tailoring composition when the flavor cloaking composition and the flavor tailoring composition are simultaneously ingested by the pregnant woman.

In a similar but alternative embodiment, a method of preparing or manufacturing a food product with taste cloaking functionalities (e.g., for tailoring the taste preferences of an unborn child) is provided comprising: determining a minimum-effective-dose “MED” of a flavor molecule which is the minimum flavor molecule dose sufficient to be perceived by the taste receptors of an in utero child; selecting a taste cloaking molecule and determining a taste cloaking molecule dose magnitude; preparing an ingestible food product which includes a taste tailoring molecular dose of at least one flavor, the taste tailoring molecular dose being provided in a molecular quantity which is greater than the MED, and additionally including the taste cloaking molecule in the ingestible food product in the determined dose magnitude; and wherein the determined taste cloaking molecule dose magnitude is so selected to activate the gustatory cortex with sufficient intensity to cloak the perception of taste of the taste tailoring molecular dose when the ingestible food product is ingested by mouth. In certain specific example embodiments (though also not intended to be limiting), the compound 1-deoxynojirimycin is utilized to mitigate possible detrimental health effects of using certain sugar based cloaking compositions, due to its abilities to inhibit sugar digestion as a glucosidase inhibitor (i.e., by reducing the amount of intestinal absorption of sugar)

In addition to using techniques or methods for mechanically or chemically cloaking or disguising taste-tailoring-molecules, the inventors of the herein described inventions have also discovered that there is a sensitivity gap between the gustatory systems of in utero infants and expectant mothers. Moreover, the inventors has discovered methods for capitalizing on these taste-sensitivity differentials so that it is possible to deliver one or a plurality of taste-tailoring-molecules to an in utero infant through the amniotic fluid of the carrying mother, but without triggering an adverse response from the mother as a consequence of the mother disliking the flavors in the taste-tailoring-molecules. In at least one such non-limiting embodiment, there is provided: a method of tailoring the taste preferences of an unborn child comprising: determining a minimum-effective-dose “MED” of a flavor molecule which is the minimum flavor molecule dose sufficient to be perceived by the taste receptors of an in utero child; determining a minimum-adult-detectable-dose “MADD” of a flavor molecule which is the minimum flavor molecule dose of the flavor molecule which is consciously perceptible as a flavor when encountered by the gustatory system of a pregnant woman carrying an in utero child; preparing an ingestible food product which includes a taste tailoring molecular dose of at least one flavor, the taste tailoring molecular dose being provided in a molecular quantity which is: greater than the MED and less than the MADD; administering the ingestible food product to a pregnant woman to influence the taste preferences of an in utero child carried in the womb of the pregnant woman; and wherein because the taste tailoring molecular dose of the food product is less than the MADD, the at least one flavor is not consciously detected by a pregnant woman which ingests the food product, but because the taste tailoring molecular dose of the food product is greater than the MED, the at least one flavor is detected by the gustatory system of an in utero child in the womb of the pregnant woman. In a similar but variant (but still non-limiting) embodiment, there is also provided a taste tailoring food (or drink) product, for influencing the taste preferences of an unborn child, comprising: at least one flavor included in the food product in a flavor molecule quantity greater than a minimum-effective-dose (“MED”) of a flavor molecule which is the minimum flavor molecule dose sufficient to be perceived by the taste receptors of an in utero child, but wherein the flavor molecule quantity is less than a minimum-adult-detectable-dose (“MADD”) of a flavor molecule which is the minimum flavor molecule dose of the flavor molecule which is consciously perceptible as a flavor when encountered by the gustatory system of a pregnant woman carrying an in utero child.

In a similar but alternative embodiment, there is provided: a method of tailoring the taste preferences of an unborn child comprising: determining a minimum-effective-dose (“MED”) of a flavor molecule which is the minimum flavor molecule dose sufficient to be perceived by the taste receptors of an in utero child; determining a maximal-adult-tolerated-dose (“MATD”) of a flavor molecule which is the maximum flavor molecule dose of the flavor molecule which is tolerated as a flavor when encountered by the gustatory system of a pregnant woman carrying an in utero child; preparing an ingestible food product which includes a taste tailoring molecular dose of at least one flavor, the taste tailoring molecular dose being provided in a molecular quantity which is: greater than the MED and less than the MATD; administering the ingestible food product to a pregnant woman to influence the taste preferences of an in utero child carried in the womb of the pregnant woman; and wherein because the taste tailoring molecular dose of the food product is less than the MATD, the at least one flavor is not rejected by a pregnant woman which ingests the food product, but because the taste tailoring molecular dose of the food product is greater than the MED, the at least one flavor is detected by the gustatory system of an in utero child in the womb of the pregnant woman. In a still similar but additional alternative (and still non-limiting) embodiments, there is also provided: a taste tailoring food (or drink) product, for influencing the taste preferences of an unborn child, comprising: at least one flavor included in the food product in a flavor molecule quantity greater than a minimum-effective-dose (“MED”) of a flavor molecule which is the minimum flavor molecule dose sufficient to be perceived by the taste receptors of an in utero child, but wherein the flavor molecule quantity is less than a maximal-adult-tolerated-dose (“MATD”) of a flavor molecule which is the maximum flavor molecule dose of the flavor molecule which is tolerable as a flavor when encountered by the gustatory system of a pregnant woman carrying an in utero child. In the embodiments discussed in this paragraph, the term maximal-adult-tolerated-dose (or acronym “MATD”) is used to define and describe a quantity of taste tailoring molecular dose which, unlike a “MADD” dose (as discussed supra), may be consciously detectable by a pregnant woman. In this regard, however, even though the dose may be (but not necessarily is) consciously detectable, the dose imparts only (at most) a subtly noticeable flavor to the edible or drinkable product which is sufficiently understated (or “muted”) such that it is not objectionable (such as likely to be rejected) if the flavor profile is one that the pregnant woman normally finds intolerable (and therefore typically rejects) when encountered at conventional flavor-strength levels. Nevertheless, because of the taste sensitivity gap discovered by applicants, the MATD dose can be selected to have a quantity of flavor molecules which is still sufficient to be detected by a child in utero sufficiently such that the unborn child becomes accustomed to the taste, adopts the taste profile as a taste which is deemed “safe” and acceptable by the child, and which is therefore a dose of sufficient magnitude to tailor the taste preferences of the child, preferably through repeated exposures.

Although the invention embodiments discussed above are described principally in relation to tailoring the taste preferences of unborn children, the taste cloaking and disguising embodiments are also useful for altering the taste preferences of post-birth children and even adults. Additionally, some embodiments of the inventions described herein relate to methods of delivering diverse food products, and the nutrients which they include, to post-birth children and adults which otherwise find the taste profiles of the delivered food (or drink) products intolerable, such that the children or adults would normally reject them.

Certain examples of the invention are now described below, with respect to certain non-limiting embodiments thereof, as illustrated in the following drawings wherein:

### BRIEF DESCRIPTION OF CERTAIN EXAMPLE DRAWINGS

The drawings submitted herewith, which form a part of this patent application, each illustrate an embodiment, or one or more components of an embodiment, of a non-limiting example of applicants' invention. While these drawings depict certain preferred embodiments of applicants' invention, as well as certain particularly desirable features thereof, they are intended to be examples only and should not be construed to limit the scope of applicants' invention.

FIG. 1 illustrates one non-limiting embodiment of methods and processes according to the subject inventions.

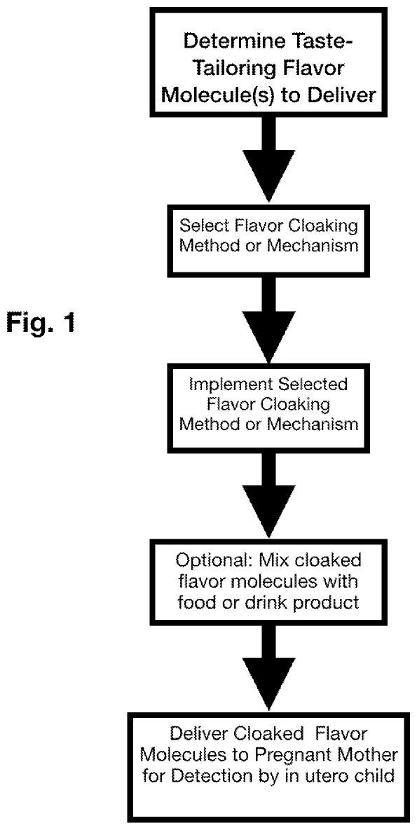

### DETAILED DESCRIPTION OF CERTAIN EXAMPLE EMBODIMENTS OF THE INVENTION

For a more complete understanding of the present invention, reference is now made to the following description of various illustrative and non-limiting embodiments thereof, taken in conjunction with the accompanying drawings in which like reference numbers indicate like features. These example embodiments, disclosed and discussed below, will assist in a further understanding of the inventions described and claimed herein, but they are not intended to limit the scope of the invention in any way.

Referencing now again the poor nutrition which (typically) results from “corporate food” diets, the difficulties of altering the taste preferences of children, and the epidemic of poor health of United States' children which has consequently presented itself (discussed in the Background section supra), the applicants have discovered (among other innovations disclosed herein) novel and innovative ways to improve the diets and therefore health of children, by tailoring their taste preferences while they are unborn and in utero. While, using the disclosed technologies, tastes can be tailored to adopt a child's preferences to almost any flavor palette, the discussion which follows herein will primarily be directed to tailoring child's taste preferences so that they accept, and perhaps even prefer, the tastes of beneficial and nutritious fruits and vegetables as well as any other advantageous food or nutrient (or product including foods or nutrients), with the goal of improving the whole-body health of the child.

In one particularly efficacious (but non-limiting) embodiment, taste-tailoring-molecules (or molecule packages) are delivered to in utero children in food products which cloak (i.e., hide) the taste of the taste-tailoring-molecules from the gustatory system of the pregnant mother, who ingests the food product with the goal of tailoring the taste preferences of the mother's in utero child. In some (but not all) of these embodiments, the taste tailoring molecules are encapsulated, such as by using specialized encapsulation techniques (e.g., microencapsulation, nanoencapsulation, or biological encapsulation). While techniques which employ natural or even organic components are preferred, synthetic compositions for encapsulation may also be used. Further, in some embodiments where it is not desirable to require the mother to ingest high caloric foods, the taste tailoring molecules may be cloaked in pill like capsules which are swallowed whole by the mother, imparting (essentially) no taste to the mother, which release the taste tailoring molecules into the digestive system so that they migrate to the amniotic fluid.

In embodiments utilizing ingestible food delivery mechanisms, the purpose of “hiding” the taste of the taste-tailoring-molecules is simple. Many American adults (as well as adults from countries with similar diets) do not enjoy the flavors of highly nutritious fruits or vegetables, such as the flavor of broccoli. Moreover, even if the flavors of foods like broccoli are tolerated in small doses, many adults do not prefer to eats foods with such flavors with sufficient frequency or in high enough quantities to adequately tailor the taste preferences of an in utero child. That is, applicants have discovered that in order for a child to adopt a new flavor as safe and acceptable, the child must be exposed to the flavor approximately twelve times during the third trimester of pregnancy. Accordingly, although it is not required, applicants envision delivering cloaked taste-tailoring-molecules in foods having tastes which are generally universally tolerated (or even enjoyed), such as (for example) foods with the flavor of chocolate (or similar well-liked flavors). Of course, unless so limited by the claims themselves, nothing in this written description (describing certain example embodiments) is intended to limit the taste of the food-delivery-vehicle to any specific flavor. Nor is this description of example embodiments intended to limit the range of taste-tailoring flavors which may be delivered to the child, while being cloaked from the mother. Similarly, the use of the term “food” is not intended to be limiting and includes whole foods, processed foods, solids, powders, liquids (including drinks), and generally any “product” which is safe to ingest and which is otherwise suitable for delivering the cloaked flavor molecules described herein.

Microencapsulation Techniques:

In at least one example embodiment in which taste-tailoring molecules (or “TTMs”) are delivered to an unborn child, the molecules are encased in cloaking compositions for the purpose of shielding the molecules from being taste-detected by the ingesting mother (carrying the child in utero). By encased, it is meant that the TTMs are physically shielded from the gustatory system of the mother. More specifically, the molecules are encased or encapsulated or otherwise physically enclosed, covered, or protected using physical barriers so that the mother's taste buds, and olfactory system, do not detect or contact the TTMs. Of course, eventually the TTMs must be “released” so that they enter the digestive system of the mother, and thereafter travel to the amniotic fluid, so that the in utero child may taste the TTMs his/herself. It is known, in this regard, that children in utero swallow amniotic fluid with frequency. Accordingly, any flavor molecules present in the fluid may be tasted by the child, and if the child is exposed to the flavors sufficiently (e.g., quantitatively and with sufficient frequency), the taste preferences of the child may be influenced and, in best, cases tailored.

Factors determined to be important by the inventors when designing physical cloaking mechanisms or techniques for the TTMs are numerous. For example, the physical cloaking (e.g., encapsulation) must be sufficiently robust to withstand degradation from the moisture and elevated temperature in the mother's mouth, as well as to survive chemical degradation due to enzymes such as amylase present in human saliva. Conversely, the physical barrier(s) must become fragile such that it/they deteriorate(s) when exposed to the environment of the mother's digestive system so that the TTMs “release” from encapsulation sufficiently soon such that the TTMs become available to transmit to the amniotic fluid. Otherwise the TTMs will be passed from the digestive system as waste, if not released soon enough, and therefore never made available to the in utero child in the amniotic fluid. In embodiments in which the TTMs are intended to be delivered to the mother (and eventually to the child) using ingestible food products, the encapsulation may also need to be designed to withstand: baking temperatures (for when the products are cooked); processing steps such as mechanical agitation when mixing ingredients of food products (e.g., health food bars or powders); and the mechanical violence of human teeth when a mother chews the food product prior to swallowing. Of course, the inventors have recognized that these obstacles can be overcome both with compositional solutions and/or by sizing the encapsulation of the TTMs (e.g., to a sufficiently small size) so that they are not readily mechanically released when the delivering-food-product is macerated by teeth.

One manner envisioned for addressing the herein described obstacles is microencapsulation. In the microencapsulation contemplated, small groups of TTMs are encapsulated within tiny-sphere like shells or coatings, which are essentially walls surrounding the TTMs and protecting them from early release in the mouth of the mother. The TTMs which are microencapsulated can be solids, or liquids, or even gases, and materials such as lipids or polymers or protein coatings (e.g., hydrolyzed pea proteins) may serve as the barrier wall which is used to encase (e.g., in a shell or coating) the TTMs inside. Examples of suitable microencapsulating materials are ethyl cellulose, polyvinyl alcohol, gelatin, and sodium alginate. Although some encapsulating techniques may result in sphere like shells, other encapsulation shapes are possible and the inventions described herein are not limited to any particle microencapsulation shape or composition. For example, depending on the qualities (e.g., size, shape, chemical composition, chemical reactivity) of the TTMs to be encased, a compatible encasing “wall” composition may be selected which may be irregular, jagged, crystalline, single walled, multi-walled, and/or involve the use of emulsions.

### Example 1

In one emulsion embodiment, for example, TTMs may be mixed into an oil in water emulsion with the emulsion thereafter spray dried to achieve a microencapsulated TTM powder. The powder can then be incorporated into other ingestible products or materials to use as a vehicle for delivering the microencapsulated TTMs to the amniotic fluid of the mother. Multi-layer membranes may also be constructed using emulsion techniques combined with the use of charged bio-polymers (among other possible, suitable non-limiting techniques).

### Example 2

In another optional example of encapsulation, lecithin and gum arabic enhanced by calcium carbonate may be employed. Lecithin is a natural compound made of a phospholipid which consists of glycerol, two fatty acids, a phosphate group and choline. Gum arabic is a gum or gummy exudate which comes from acacia trees. It is a natural branched chain, hetero polysaccharide, neutral polysaccharide mainly found as a mixed salt of polysaccharidic acids, such as a magnesium and potassium. Gum arabic contains the I-arabinose, I-rhamnose, and d-glucuronic acid and 1,3-linked-d-galactopyranosyl units. Gum arabic possesses a broad range of health benefits and is also a rich source of dietary fibers. Calcium carbonate is a chemical compound with the formula CaCO₃. In this method, utilizing such compositions, an inverse phospholipid calcium complex was created that was then mixed with gum arabic. Additionally, an emulsifying agent is employed to stabilize flavoring molecules, such as those of vegetables and fruits. In order to provide taste tailoring for an in utero child, fruit and vegetable flavor molecules (e.g., in the form of powders), in suitable dosages, are encapsulated with the inverse phospholipid calcium complex and then mixed with other food products which are intended for the mother to taste. For example, in one embodiment, pumpkin seed butter and liquid inulin fiber date fruit paste are added, and then the contents mixed, to create a finished food product. In addition to providing the flavor cloaking and taste tailoring benefits, the technique also mitigates oxidation of vegetable and fruit flavoring molecules, improving their bioavailability for the in utero child. More specifically, in this optional example embodiment, the following ingredients and process steps are used:

### Matrix Ingredients List (25 Gram Dosage):

3.5 grams date paste
7.25 pumpkin seed butter
1.1 gram olive oil
20 mg KCL (potassium chloride)
360 mg gum arabic powder
2.5 grams liquid lecithin
1.2 grams cacao
600 mg erythritol
1 gram inulin
450 mg flaxseed oil
1 gram mulberry powder
1300 mg of calcium as calcium carbonate
1000 IU Vitamin D3
80 mcg Vitamin K1

### Phase 1:

Tools Used: Scale, Small spice grinder, Parchment paper cups for measuring
1. Begin by taring the scale to the weight of the parchment paper cup
2. Measure 2.5 grams of Liquid Sunflower Lecithin and add contents into the mixer (small spice grinder)
3. Using a new measuring cup, measure 1.3 grams of calcium carbonate and add into the mixer
4. Place lid firmly on mixer and blend Liquid lecithin and calcium carbonate for 10-15 seconds or until fully incorporated (should become a light brown color)

### Phase 2:

5. Keep the contents of the Liquid lecithin and calcium carbonate mixture inside of the mixer
6. Using the scale, measure 3.5 grams of date paste. Add to the mixer (do not blend)
7. Measure 7.25 grams Pumpkin Seed Butter and add to the mixer (do not blend)
8. Measure 1.1 grams of Olive oil and add the mixer (do not blend)
9. Measure 450 mg of Flaxseed oil to the mixer and blend all liquid ingredients for 10 seconds or until fully incorporated (do not blend contents for longer than 20 seconds as the grinder will begin to increase in temperature and effect the consistency of the matrix)

### Phase 3 (Adding Dry Matrix Ingredients):

10. Collect Tools Needed: Clean Metal Spoons, parchment paper cups for measuring, Small scale (to measure mg), large scale (to measure grams)
11. Tare the mg scale to the weight of a new measuring cup
12. Using a clean spoon, measure 20 mg of KCL (potassium chloride)
13. Add KCL to mixer
14. Measure 360 mg of Gum Arabic Powder and add to mixer (do not mix yet)
15. Measure 10 mg of Vitamin D3 and add to mixer (do not mix yet)
16. Measure 8 mg of Vitamin K1 and add to mixer (do not mix)
17. Measure 600 mg of erythritol and add to the mixer
18. Using the larger scale, tare scale to weight of measuring cup
19. Using a clean spoon measure 1.2 grams of Cacao Powder and add to mixer.
20. Measure 1 gram of inulin and add to mixer
21. Measure 1 gram of Mulberry Powder and add to mixer
22. Secure lid firmly on mixer and blend all ingredients for 10 seconds.
23. Remove lid, using a clean spoon, scrape edges of mixer and bottom crevices (liquid contents will stay at the bottom if some manual incorporation is not conducted)
24. Place lid onto mixer and blend for another 10 seconds (Continue steps 22 and 23 until the mixture is noticeably incorporated and no single ingredient can be identified in the mix)

Note: Do not blend ingredients for more than 10 seconds at a time, this causes the motor of the mixer to produce heat which can alter the consistency and texture of the matrix material)

### Phase 4 (Creating 25 Gram Bars):

Tools Needed: Large scale, parchment paper cups, clean metal spoons, Spice grinder for mixing, Functional Ingredient powders, Dab Press compression device, Rubber mallet hammer, magazine (to protect surface of counter), Large sheet of parchment paper (clean space to place compressed bar)
1. Once desired consistency of matrix is achieved tare your scale to the weight of a parchment paper measuring cup
2. Place contents of matrix into parchment paper cup and place on scale
3. For the 25 gram dose, you should have a total of 19 grams of matrix material
4. Clean Mixer with paper towels until all residue of matrix material is gone
5. Starting with Group 1 of the Functional Ingredients, measure 6 grams of functional ingredient powder for group 1
6. Add contents into mixer
7. Add 19 grams of matrix material into mixer
8. Blend Functional Ingredients and matrix material in 5 second intervals until desired consistency is reached. (should not have any noticeable powder or clumps, it will be a medium chocolate color and smooth)
   Note: After every 5 second Interval of mixing, use a clean spoon to scrape sides and lid of mixer to ensure all contents are being incorporated evenly.
9. Using the large scale, tare to the weight of a new parchment paper cup
10. Transfer contents of Mixer into cup to ensure 25 grams of total material is achieved
11. Place Dab Press on top of soft magazine (protects counters when hammering of Dab Press begins)
12. Ensure the bottom of the Dab Press is secure, and top is taken off (Top of Dab press is the large cylinder that is heavy)
13. Place contents of 25 gram material into the open cylinder of Dab Press, and place the Top inside. Press down slightly
14. Using the Rubber Mallet hammer, strike top of Dab Press 10-15 times in a consistent and precise manner (Hold the Dap Press in one hand to keep it stable during hammering)
15. Grabbing the Top and Middle part of the Dab press, slowly lift as bar begins to be revealed at the bottom (Ensure to go slow and evenly during this step to prevent any sticking or loss of material)
16. Place compressed bar onto clean parchment paper sheet and let sit for 30 seconds to a minute
17. Repeat Steps 1-4 in all previous slides for each group/day

### Phase 5:

1. With the compressed bar, place on side and divide into 4 even pieces by cutting with a large knife
2. Place into labeled parchment paper cup (Labeled by group/day so there is no confusion on groups)
3. Place a small Pot with 1 inch of water on stove on low-medium heat. Place glass pyrex dish on top of pot (make sure the glass dish covers the pot completely and does not touch the water)
4. Measure 50 grams of chocolate wafers on scale, and add to glass dish
5. As chocolate begins to melt, begin mixing with a clean metal spoon to achieve an even melt
6. Do not allow any water/moisture near chocolate as this will compromise the melting and make the chocolate stiffen
7. Once all of the chocolate is melted to an even texture, take glass dish with chocolate away from heat
8. Using a clean fork, place one bite size piece of group 1 into chocolate, completely covering the bar
9. Scoop piece out by placing fork under the bar. Tap fork on corner of glass dish to allow excess chocolate to drip off and remove any air bubbles
10. Place chocolate dipped piece back into labeled parchment paper cup
11. Repeat above steps for each group and place all contents on white tray
12. Place two large parchment paper pieces on top of all bars and place in the fridge
13. Allow to cool for 3-6 hours before removing from the fridge
   Note: Once cooled down, do not allow the chocolate dipped bars to be in a temperature higher than 75 degrees Fahrenheit as it will cause melting.
   Of course, the above example manufacturing process is an illustrative example only, and other processes and/or methods and/or suitable ingredients may be used.

Once a encapsulation method or mechanism is selected which is appropriate for the TTMs to be delivered (e.g., spinach flavor molecules may warrant different encapsulating techniques than carrot TTMs), the encapsulated, protected TTMs may be incorporated into food (or other ingestible) products such as food bars (similar to energy bars, protein bars, candy bars, cereal bars, etc.), mixable drink powders (e.g., powdered shakes), pre-packaged drinks (e.g., in bottles, cans, jars, cartons, etc.), or any other suitable food or food like vehicle. It is contemplated, though not required, that the food (or food-like) vehicle have an attractive taste for the mother carrying the unborn child, so that the mother will ingest the food vehicle containing the TTMs in sufficient quantity, and with sufficient frequency, for the unborn baby to be exposed to the flavor of the TTMs a sufficient number of times, and with sufficient flavor intensity, so that the baby remembers the TTM flavor(s) post-birth, and therefore judges such TTM flavor(s) as desirable or at least safe and not offensive to eat. Regardless of the food vehicle flavor, however, it is important that the unborn baby be exposed to desired TTM flavors as frequently as possible. Nevertheless, the applicants herein have discovered that—for many children—it is necessary to expose a child to a new flavor at least twelve times during a three-month period before the child begins to tolerate the flavor as safe and acceptable (and hopefully eventually desirable). Accordingly, in some embodiments of the inventions described herein, it is envisioned that cloaked TTMs will be—similar to a prescription—recommended or instructed for ingestion by a pregnant mother according to a pre-defined regimen. An (non-limiting) example regimen, or cloaked-TTM ingestion schedule is described below:

Third Trimester of Pregnancy
Beginning during approximately week 28 of pregnancy, administer gram-sufficient, flavor-cloaked dose to pregnant mother at least every 6-8 days;
Continue “weekly” delivery of gram-sufficient flavor-cloaked dose to pregnant mother for at least twelve weeks.
   Given the benefits of adhering to such an (example) cloaked-TTM ingestion schedule, at least one embodiment of the inventions described herein pertains to packaging food products which include TTMs into kits or packages or programs to increase efficacy of the taste-tailoring food deliveries for children of the mothers which ingest them. For example, the TTMs may be packaged in food bars which are ingested on designated days of the week (or every day for 14 days, for a particular flavor, for example).

Dosing Techniques:

As an alternative (or supplement) to the microencapsulation techniques described herein, applicants have discovered novel and inventive ways to taste-tailor (or influence) children's taste preferences by taking advantage of the discovered sensitivity gaps between the gustatory systems of unborn children and adults. That is, children in utero are believed to perceive the taste of flavors at lower molecular dose exposures (at least when “tasting” via amniotic fluid) than adults, such as compared to the pregnant mother carrying the same child. These discovered techniques principally involve delivering one (or a plurality) of taste-tailoring-molecules to an in utero infant through the amniotic fluid of the carrying mother, in a quantitative dose which has sufficient magnitude to influence the taste preferences of the child (after a sufficient number of total doses in aggregate), but whereas the does is sufficiently small in magnitude such that it is not detected by the less sensitive gustatory system of the pregnant mother. In other words, the TTMs are delivered, in this example embodiment, without being physically encapsulated but instead are delivered in a small enough dose such that either the flavor is not detected by the mother at all, or the flavor is sufficiently low in intensity such as to avoid triggering an adverse response from the mother as a consequence of the mother disliking the flavors in the taste-tailoring-molecules.

Producing a taste-tailoring food product, which accomplishes these objectives, is accomplished in one particularly desirable (even though non-limiting) embodiment according to the following steps:
A mean minimum-effective-dose “MED” of a flavor molecule, which is the minimum flavor molecule dose sufficient to be perceived by the taste receptors of an in utero child, is determined for a particular TTM. It is recognized, of course, that different food flavors may have different MEDS so tailoring the MED for the specific TTM is recommended even though not required. A “mean” dose is employed in this example embodiment because it is likely to result in acceptable taste-influencing efficacy, even though some atypical children at boundaries of tested ranges may not sufficiently consciously perceive the taste of the mean dose;
A mean minimum-adult-detectable-dose “MADD” of a flavor molecule, which is the minimum flavor molecule dose of the flavor molecule which is consciously perceptible as a flavor when encountered by the gustatory system of a pregnant woman carrying an in utero child, is determined for a particular TTM. Like with the determined MEDS, MADD doses can be determined and therefore tailored quantitatively in specific food products for each specific TTM. Similarly, a mean MADD is determined to attempt to reach maximum efficacy for a taste influencing campaign or program, for any randomly selected group sample size of pregnant women (while recognizing that some atypical mothers will be unusually sensitive to taste molecule deliveries);
An ingestible food product is prepared which includes a taste tailoring molecular dose of at least one flavor (i.e., it includes at least one TTM). The taste tailoring dose or TTM delivery in this embodiment, however, is not shielded from the taste (or olfactory) senses of the pregnant mother using physical or mechanical barriers. Instead, the TTM is delivered in a molecular quantity which is: 1) greater than the determined mean MED for the selected TTM flavor; and 2) less than the determined mean MADD for the selected TTM flavor.

When TTMs are delivered to a pregnant mother in doses selected according to these criteria, the food product delivery is believed to be suitable to influence or tailor the taste preferences of the in utero child, while not offending the personal taste preferences of the mother carrying the child (who preferably does not consciously detect the taste of the delivered TTM(s)). This is because the food product which serves as the delivery vehicle for the TTMs is (preferably, but not necessarily) formulated to include widely accepted flavor profiles (in contrast to the TTM flavor profile itself).

While it is ideal in the embodiments leveraging taste sensitivity gaps between the mother and child for the TTM dose employed to not be consciously taste-detected by the mother, in optional alternative embodiments it is desirable to use different dosing criteria, possibly because the taste sensitivity gaps for a specific TTM are smaller than conventional (or to save costs in research and development and/or manufacturing and/or quality control). In some of these alternative embodiments, the following steps are performed to produce a taste-tailoring food product:
A mean minimum-effective-dose “MED” of a flavor molecule, which is the minimum flavor molecule dose sufficient to be perceived by the taste receptors of an in utero child, is determined for a particular TTM. Like in the above-discussed examples, it is recognized that different food flavors may have different MEDS so tailoring the MED for the specific TTM may be recommended. Moreover, like in the above prior example, a “mean” MED dose is preferably employed for the reasons already discussed;
In contrast to the prior example (pertaining to “MADD”), a mean maximal-adult-tolerated-dose “MATD” of a flavor molecule, which is the maximum flavor molecule dose of the flavor molecule which is consciously detected but still tolerated as a flavor when encountered by the gustatory system of a pregnant woman carrying an in utero child, is determined for a particular TTM. Like with the determined MADDs, a mean MATD is determined to attempt to reach maximum efficacy for a taste influencing campaign or program, for any randomly selected group sample size of pregnant women (while again recognizing that some atypical mothers will be unusually sensitive to taste molecule deliveries);
An ingestible food product is prepared which includes a taste tailoring molecular dose of at least one flavor (i.e., it includes at least one TTM). The taste tailoring dose or TTM delivery in this embodiment, however, is not shielded from the taste (or olfactory) senses of the pregnant mother using physical or mechanical barriers. Nor is the TTM entirely undetected by the pregnant mother. Instead, the TTM is delivered in a molecular quantity which is: 1) greater than the determined mean MED for the selected TTM flavor; and 2) less than the determined mean MATD for the selected TTM flavor.

Like with the prior example where the TTMs are delivered with the intention of effectively zero conscious taste recognition by the pregnant mother, the prepared food product is thereafter delivered to a pregnant woman for consumption to influence the taste preferences of her in utero child. Furthermore—beneficially—because the TTM dose is less than the MATD, the food product is not rejected by a pregnant woman but instead is ingested a sufficient number of times (to provide a suitable number of taste exposures to the child) to influence the taste preferences of her child. By way of additional explanation, although (in the embodiments discussed in this paragraph) the term maximal-adult-tolerated-dose (or acronym “MATD”) is used to define and describe a quantity of taste tailoring molecular dose which may be consciously detectable by a pregnant woman, the dose is preferably tailored to impart only a subtly noticeable flavor to the edible or drinkable product which is sufficiently understated (or “muted”) such that it is not objectionable (such as likely to be rejected) if the flavor profile is one that the pregnant woman normally finds intolerable when encountered at conventional flavor-strength levels. Even so, because of the taste sensitivity gap discovered by applicants, the MATD dose is sufficiently intense when detected by the in utero child such that the unborn child becomes accustomed to the taste, and adopts the taste profile as a taste which is deemed “safe” and acceptable.

Biological and/or Chemical Flavor Cloaking:

In addition to the physical encapsulation and dose-gapping technologies and methods disclosed herein above, the applicants have also discovered methods for delivering taste-tailoring doses of beneficial flavor molecules using biological and chemical cloaking techniques. These cloaking techniques, rather than physically shielding the TTMs from the mother's taste buds, or delivering the TTMs at an undetectably small dose level, instead utilize an additional molecular element (or elements) to overwhelm or trick the gustatory system of the person first ingesting them.

For example, if a pregnant woman wishes to influence her unborn child's taste preferences to include broccoli, but she herself dislikes eating broccoli, applicants have discovered a method of cloaking the broccoli taste from the mother, even though the taste molecules are not physically encased or shielded. This is all done while efficaciously delivering the broccoli taste dose (i.e., TTM) to her unborn child via her amniotic fluid. In one embodiment, for example, taste cloaking molecules are paired with an effective TTM dose whereby the specific taste cloaking molecules are included and utilized to intentionally bind to the sweet receptor taste buds of the tongue which activate the sweet-responsive subregion of the gustatory cortex. When included and utilized in a dose of sufficient magnitude, these taste cloaking molecules are sufficient to temporarily biologically “trick” a mother ingesting the taste cloaking molecules paired with the TTMs into not perceiving the TTM flavor profile as objectionable.

In one example embodiment of a cloaking method discovered by applicants, the following steps are employed:
A mean minimum-effective-dose “MED” of a flavor molecule, which is the minimum flavor molecule dose sufficient to be perceived by the taste receptors of an in utero child, is determined for a particular TTM. A “mean” dose is employed in this example, as in the other example embodiments, because of the combination of efficacy and efficiency achieved;
A taste cloaking molecule and dose magnitude is selected which is functionally adequate to activate the gustatory cortex to cloak the perceptible taste profile of the selected MED/TTM dose;
An ingestible food product is prepared which includes a taste tailoring molecular dose of at least one flavor (i.e., it includes at least one TTM) paired with the taste cloaking molecule dose selected.
   Although various types of sugars have been contemplated for activating the sweet receptors, sugar itself can be unhealthy and sometimes even dangerous if used in high molecular doses to achieve cloaking potency, particularly in pregnant women (e.g., because of effects on insulin). This is, of course, a concern given the purposes of the herein described inventions to influence or tailor the taste preferences of unborn children. Fortunately, the applicants have discovered that sugar cloaking doses can be delivered with sufficient molecular magnitude, with minimal or no ill health effect, if paired with 1-deoxynojirimycin. This compound, in particular, inhibits sugar digestion as a glucosidase inhibitor (i.e., by reducing the amount of intestinal absorption of sugar). 1-deoxynojirimycin is also believe to accelerate hepatic glucose metabolism. The functionalities of 1-deoxynojirimycin, in other words, prevent increases and even reduce blood sugar levels rendering potent cloaking doses safe for consumption.

Although other cloaking molecules may be employed, and although other methods for obtaining 1-deoxynojirimycin may be utilized, applicants have beneficially discovered that mulberries in particular include the desirable blood sugar reducing composition, useful for pairing with the taste-molecule-cloaking and TTM doses as described herein. Although numerous types of mulberries exist, such as the species Morus alba (White Mulberry), Morus rubra (Red Mulberry) and Morus nigra (Black Mulberry), applicants have studied and believe that the Himalayan mulberry Morus macroura is the most desirable and efficacious variety. Being suitable compositionally, in certain non-limiting embodiments, it is contemplated to pair mulberry (of any suitable variety subject to compositional testing) with TTMs in packaged food products for achieving the taste-influencing or tailoring objectives described herein.

While the above-embodiments have been described with respect influencing or tailoring the taste preferences of unborn children, it has been recognized by the applicants that taste molecules, in addition to being delivered to unborn babies in the amniotic fluid, are also delivered in breast milk to babies which breast feed. Consequently, the above technologies and solutions are equally applicable to mothers of post-birth children that are breast feeding, or which intend to breast feed. For example, a mother who was unaware of the opportunity to taste-tailor her child in utero may learn of the opportunity post-birth while her child is still breast feeding. In such example circumstance, the mother can ingest the inventive food products which include cloaked (e.g., encapsulated) TTMs to expose her child to healthy, nutritious food flavors (e.g., thereby tailoring her child's food preferences) for improving the long term diet and health of her child. Similarly, to add insurance to the efficacy of the taste-tailoring techniques, a mother may choose to use the herein described technologies both pre-birth and post child birth while breastfeeding.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined:

We claim:

1. A method of tailoring the taste preferences of an unborn child comprising:
determining a minimum-effective-dose “MED” of a flavor molecule which is the minimum flavor molecule dose sufficient to be perceived by the taste receptors of an in utero child;
determining a maximal-adult-tolerated-dose “MATD” of a flavor molecule which is the maximum flavor molecule dose of said flavor molecule which is tolerated as a flavor when encountered by the gustatory system of a pregnant woman carrying an in utero child;
preparing an ingestible food product which includes a taste tailoring molecular dose of at least one flavor, said taste tailoring molecular dose being provided in a molecular quantity which is:
greater than said MED
and
less than said MATD
administering said ingestible food product to a pregnant woman to influence the taste preferences of an in utero child carried in the womb of said pregnant woman; and
wherein because said taste tailoring molecular dose of said food product is less than said MATD, said at least one flavor is not rejected by a pregnant woman which ingests said food product, but because said taste tailoring molecular dose of said food product is greater than said MED, said at least one flavor is detected by the gustatory system of an in utero child in the womb of said pregnant woman.

2. A taste tailoring food product, for influencing the taste preferences of an unborn child, comprising:
at least one flavor included in said food product in a flavor molecule quantity greater than a minimum-effective-dose “MED” of a flavor molecule which is the minimum flavor molecule dose sufficient to be perceived by the taste receptors of an in utero child, but wherein said flavor molecule quantity is less than a maximal-adult-tolerated-dose “MATD” of a flavor molecule which is the maximum flavor molecule dose of said flavor molecule which is tolerable as a flavor when encountered by the gustatory system of a pregnant woman carrying an in utero child.

3. A method of tailoring the taste preferences of an unborn child comprising:
determining a minimum-effective-dose “MED” of a flavor molecule which is the minimum flavor molecule dose sufficient to be perceived by the taste receptors of an in utero child;
determining a minimum-adult-detectable-dose “MADD” of a flavor molecule which is the minimum flavor molecule dose of said flavor molecule which is consciously perceptible as a flavor when encountered by the gustatory system of a pregnant woman carrying an in utero child;
preparing an ingestible food product which includes a taste tailoring molecular dose of at least one flavor, said taste tailoring molecular dose being provided in a molecular quantity which is:
greater than said MED
and
less than said MADD
administering said ingestible food product to a pregnant woman to influence the taste preferences of an in utero child carried in the womb of said pregnant woman; and
wherein because said taste tailoring molecular dose of said food product is less than said MADD, said at least one flavor is not consciously detected by a pregnant woman which ingests said food product, but because said taste tailoring molecular dose of said food product is greater than said MED, said at least one flavor is detected by the gustatory system of an in utero child in the womb of said pregnant woman.

4. A taste tailoring food product, for influencing the taste preferences of an unborn child, comprising:
at least one flavor included in said food product in a flavor molecule quantity greater than a minimum-effective-dose “MED” of a flavor molecule which is the minimum flavor molecule dose sufficient to be perceived by the taste receptors of an in utero child, but wherein said flavor molecule quantity is less than a minimum-adult-detectable-dose “MADD” of a flavor molecule which is the minimum flavor molecule dose of said flavor molecule which is consciously perceptible as a flavor when encountered by the gustatory system of a pregnant woman carrying an in utero child.

5. A food product for tailoring the taste preferences of a child in utero, wherein said food product includes means to cloak at least a first flavor to prevent a pregnant woman from consciously taste-recognizing said at least first flavor; and
wherein, after said food product is ingested by a pregnant woman and has passed by the gustatory system of said pregnant woman, said means to cloak said at least first flavor is designed to thereafter uncloak said first flavor, such that said first flavor is taste-recognizable by an infant in utero carried in the womb of said pregnant woman.

6. A food product according to claim 5 wherein said means to cloak comprises an encapsulating mechanism for encapsulating flavor molecules so that such flavor molecules are not consciously detected by the gustatory system of a pregnant woman ingesting such encapsulated flavor molecules; and
wherein said encapsulating mechanism releases said flavor molecules after passing by the gustatory system of said pregnant woman such that said flavor molecules are non-encapsulated within the amniotic fluid of said pregnant woman such that an infant in utero taste-recognizes said flavor molecules.

7. A food product for tailoring the taste preferences of a child in utero comprising:
a first composition comprising a flavor cloaking composition;
a second composition comprising a flavor tailoring composition; and
wherein said flavor cloaking composition is compositionally configured to be detected by the gustatory system of said pregnant woman and is further compositionally configured to suppress said pregnant woman's gustatory detection of said flavor-tailoring composition when said flavor cloaking composition and said flavor tailoring composition are simultaneously ingested by said pregnant woman.

8. A method of tailoring the taste preferences of an unborn child comprising:
determining a minimum-effective-dose “MED” of a flavor molecule which is the minimum flavor molecule dose sufficient to be perceived by the taste receptors of an in utero child;
selecting a taste cloaking molecule and determining a taste cloaking molecule dose magnitude;
preparing an ingestible food product which includes a taste tailoring molecular dose of at least one flavor, said taste tailoring molecular dose being provided in a molecular quantity which is greater than said MED, and additionally including said taste cloaking molecule in said ingestible food product in said determined dose magnitude; and
wherein said determined taste cloaking molecule dose magnitude is so selected to activate the gustatory cortex with sufficient intensity to cloak the perception of taste of said taste tailoring molecular dose when said ingestible food product is ingested by mouth.

9. The method according to claim 1, further comprising administering said ingestible food product to a pregnant woman at least approximately twelve times within a time frame of approximately twelve weeks.

10. The method according to claim 10, wherein said ingestible food product is first administered to a pregnant woman beginning between the 27^{th} and 29^{th} weeks of pregnancy.

11. The food product according to claim 5, wherein said food product is selected from the group consisting of: a solid food, a gel food, a powered food, and a liquid food.

12. The food product according to claim 5 wherein said means to cloak is a dissolvable capsule encasing said at least first flavor.

13. The food product according to claim 11 wherein said wherein said food product is administered to a pregnant woman beginning approximately between the 27^{th} and 29^{th} weeks of pregnancy, and is administered at least approximately twelve times within a time span of approximately twelve weeks.

14. The food product according to claim 13, further wherein at least approximately twelve dose-portions of said food product are packaged in a kit for consumption by a pregnant mother.

15. The method according to claim 1 wherein said ingestible food product is selected from the group consisting of: a solid food, a gel food, a powered food, and a liquid food.

16. The method according to claim 15 wherein said ingestible food product is packaged in a kit comprising at least approximately twelve dose-portions for consumption by a pregnant mother.
